(19) United States
(12) Patent Application Publication
(10) Pub. No.: US 2014/0182721 A1
(43) Pub. Date: Jul. 3, 2014

(54) PRESSURE BALANCED COUPLER

(71) Applicant: Parker-Hannifin Corporation, Cleveland, OH (US)

(72) Inventor: Gordon Rowe, Southington, CT (US)

(21) Appl. No.: 14/138,268

(22) Filed: Dec. 23, 2013

Related U.S. Application Data
(60) Provisional application No. 61/746,982, filed on Dec. 28, 2012.

(51) Int. Cl. F16L 37/367

(52) U.S. Cl. CPC F16L 37/367
USPC 137/614.2

(57) ABSTRACT

Provided is a pressure balanced coupler including male and female couplers configured to be coupled together, the male coupler having a stab removably coupled to a plug in the female coupler to move the plug from a closed position preventing fluid flow to a port in the female coupler and an open position allowing flow. In this way, a pressure balanced coupler for use with high pressure fluids in high pressure environments may be provided that does not have a net load acting to separate the male and female couplers.

### RELATED APPLICATIONS

This application claims the benefit of U.S. Provisional Application No. 61/746,982 filed Dec. 28, 2012, which is hereby incorporated herein by reference.

### FIELD OF INVENTION

The present invention relates generally to fluid couplers, and more particularly to pressure balanced fluid couplers.

### BACKGROUND

Fluid couplers may be used for subsea applications, for example in connection with oil wells. To connect one fluid line to another, quick connect/disconnect couplings may be used. The quick connect/disconnect couplings include a male member and a female member connected to respective fluid lines. The male and female members are sealed to prevent sea water from entering the fluid lines and to minimize spilling of fluid, such as hydraulic fluid, flowing through the lines.

The male and female members may each include a check valve that is opened when the members are connected and which moves to a closed position when the members are disconnected. The male and female members may be connected/disconnected either manually by a diver or automatically by a diverless system, for example.

### SUMMARY OF INVENTION

The present invention provides a pressure balanced coupler including male and female couplers configured to be coupled together, the male coupler having a stab removably coupled to a plug in the female coupler to move the plug from a closed position preventing fluid flow to a port in the female coupler and an open position allowing flow. In this way, a pressure balanced coupler for use with high pressure fluids in high pressure environments may be provided that does not have a net load acting to separate the male and female couplers.

According to an aspect of the invention, a pressure balanced coupler is provided that includes a female coupler including a body having a bore and a port in a sidewall of the bore, and a plug disposed in the bore, the plug movable between a closed position blocking fluid from entering the port and an open position allowing fluid to enter the port, and a male coupler configured to be received in the female coupler, the male coupler including a body defining a stab configured to be received in a bore of the plug and removably coupled to the plug and a port opening to a sidewall of the stab, wherein when the stab and plug are removably coupled the plug moves axially with the stab to the open position allowing for communication between the port in the female coupler and the port in the male coupler for enabling flow of fluid through the coupler, and upon removal of the male coupler the plug will move axially with the stab until the plug reaches the closed position after which the stab will be disconnected from the plug to allow for further withdrawal of the stab while the plug is held in the closed position.

The plug includes a locking mechanism that engages the stab so that the plug will move axially with the stab.

Upon removal of the male coupler from the female coupler, the stab will be disengaged from the locking mechanism when the plug reaches the closed position.

The locking mechanism includes at least one detent configured to be seated in a groove on the stab when the stab and plug are coupled and in a seat in the wall of the bore when the plug is in the closed position.

The female coupler further includes at least one metal seal disposed between an outer wall of the female plug and a wall of the bore, the at least one metal seal providing frictional resistance to movement of the plug to enable the locking mechanism to lock the stab to the plug and to allow the stab to move out of the plug once the plug is in the closed position and the locking mechanism is released.

The female coupler further includes at least one passage radially offset from the bore, the passage being in fluidic communication with the bore via the port.

The female coupler further includes at least one vent hole extending from the inner wall of the bore to an outer wall of the body for allowing fluid in the bore to communicate with an exterior of the female coupler.

The bore extends from a first end of the body to a closed inner end of the body.

A cavity is formed in the bore between the closed inner end and the plug, and wherein the at least one vent hole is provided in the cavity.

The male coupler further includes a collar surrounding at least a portion of the body, the body being movable relative to the collar.

The male coupler includes a locking mechanism that engages a wall of the bore in the body of the female coupler to hold the collar in position in the bore.

The body is movable between a closed position blocking fluid from flowing through the port and an open position allowing fluid to flow through the port.

The locking mechanism includes at least one detent configured to be seated in a groove on the body of the male coupler when the stab and plug are uncoupled and in a seat in the wall of the bore when the plug is in the open position.

When the plug returns to the closed position, the detent in the male coupler will be disengaged from the seat in the wall of the bore.

The male coupler further includes at least one metal seal disposed between an outer wall of the stab and an inner wall of the collar.

According to another aspect of the invention, a female coupler configured to couple to a male coupler is provided. The female coupler includes a body having a bore and a port in a sidewall of the bore, a plug disposed in the bore, the plug including a locking mechanism configured to engage a stab of the male coupler so that the male coupler can move the plug between a closed position blocking fluid from entering the port and an open position allowing fluid to enter the port, and at least one metal seal disposed between an outer wall of the female plug and a wall of the bore, the at least one metal seal providing frictional resistance to movement of the plug to enable the locking mechanism to lock the stab to the plug and to allow the stab to move out of the plug once the plug is in the closed position and the locking mechanism is released.

The locking mechanism includes at least one detent configured to be seated in the wall of the bore when the plug is in the closed position.

According to yet another aspect of the invention, a male coupler configured to be coupled to a female coupler is provided. The male coupler includes a body defining a stab configured to be received in a bore of the female coupler and a port opening to a sidewall of the stab, the body being configured to be removably coupled to the female coupler, a collar surrounding at least a portion of the body, and a locking mechanism configured to engage a wall of the bore in the body of the female coupler to hold the collar in position in the bore when the male coupler is coupled to the female coupler, wherein the body is movable relative to the collar.

The locking mechanism includes at least one detent configured to be seated in a groove on the body when the male and female couplers are uncoupled.

According to still another aspect of the invention, a method of coupling/uncoupling a female and male coupler is provided. The method includes inserting the male coupler into a bore in a body in the female coupler to removably couple a stab of the male coupler and a locking mechanism in a plug in the bore of the female coupler, and advancing the stab to move the plug axially with the stab from a closed position blocking fluid from entering a port in the body to an open position allowing for communication between the port in the female coupler and a port in the male coupler for enabling flow of fluid through the couplers.

The method additionally includes, upon removal of the male coupler, moving the plug axially with the stab until the plug reaches the closed position, and disconnecting the stab from the plug to allow for further withdrawal of the stab while the plug is held in the closed position.

The foregoing and other features of the invention are hereinafter described in greater detail with reference to the accompanying drawings.

### BRIEF DESCRIPTION OF THE DRAWINGS

FIG. 1 is a cross-sectional view of an exemplary pressure balanced coupler according to the invention showing a female and male coupler coupled together.

FIG. 2 is another cross-sectional view of the exemplary pressure balanced coupler showing the female and male coupler uncoupled.

FIG. 3 is still another cross-sectional view of the exemplary pressure balanced coupler.

FIG. 4 is yet another cross-sectional view of the exemplary pressure balanced coupler.

### DETAILED DESCRIPTION

The principles of the present application have particular application to pressure balanced couplers for subsea applications for conveying a high pressure fluid and thus will be described below chiefly in this context. It will of course be appreciated, and also understood, that the principles of the invention may be useful in fluid coupling applications where it is desirable to have no net load acting to separate the male and female couplers.

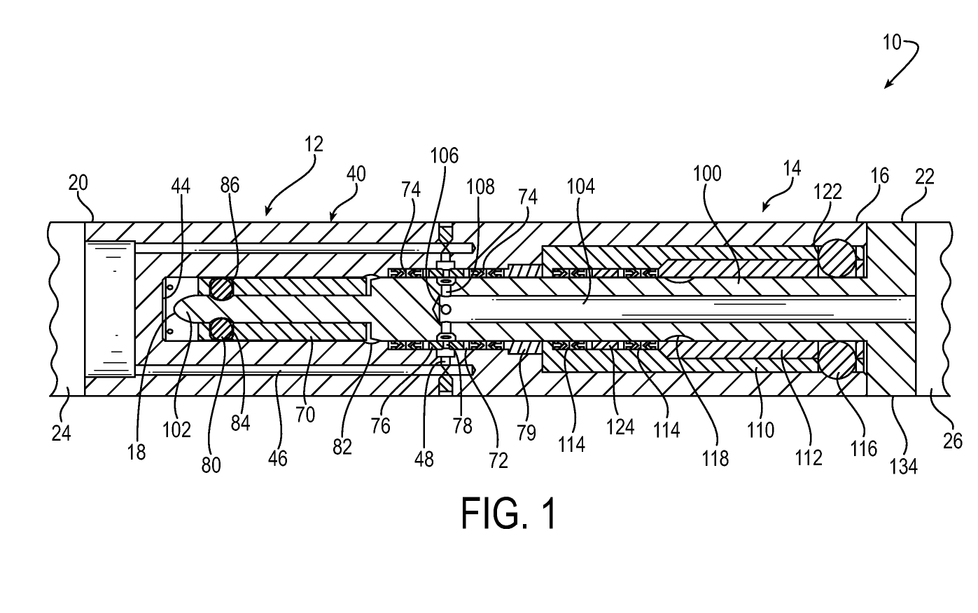

Turning now to FIG. 1, an exemplary pressure balanced mono coupler pair is illustrated generally at reference numeral 10. The coupler 10 includes a female coupler 12 and a male coupler 14. The female coupler 12 has a first end 16 configured to receive a first end 18 of the male coupler 14, and each coupler has a second end 20, 22 configured to couple to a respective fluid line 24, 26 by any suitable means, such as by quick connect fittings, threads, etc. When the male and female couplers are connected, fluid, such as hydraulic fluid, can flow from one fluid line to another.

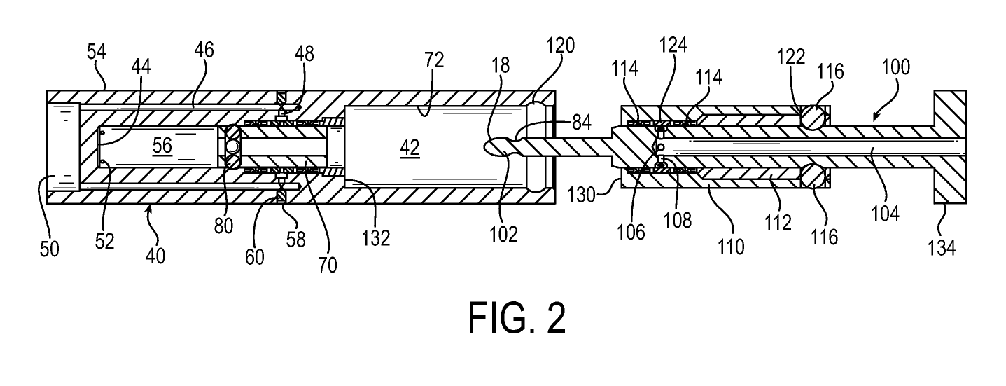

Referring now to FIGS. 1 and 2, the female coupler 12 includes a body 40 having a bore 42 extending from the first end 16 to an inner end 44 of the body, which may be a closed inner end. The bore may have various diameters along a length of the body as described below. The body also includes at least one passage 46 radially offset from the bore 42, and in the illustrated embodiment a plurality of passages 46. Each passage 46 is in fluidic communication with the bore 42 via a respective port 48, which may be a radially outwardly extending pathway, and in fluidic communication with the fluid line 24 via a chamber 50. The passages 46 may be formed in any suitable manner, for example by drilling into the body from the second end 20 towards the first end 16.

The body 40 also includes at least one vent hole 52 in the bore 42 adjacent the closed inner end 44 of the body 40, and in the illustrated embodiment a plurality of vent holes 52. The vent holes extend to an outer wall 54 of the body 40 for allowing fluid, such as water, to flow into and out of a cavity 56 formed in the bore 42 between the closed inner end 44 and a seal plug 70.

The body 40 further includes a plurality of ports 58 that intersect the respective passages 46 and extend radially outward from the respective passage 46 to the outer wall 54. During machining of the female coupler, the ports 48 and 58 are drilled through the outer wall 54 and then the ports 58 are plugged to prevent fluid from flowing into or out of the female coupler via the ports 58. The ports 58 may be plugged in any suitable manner, for example by a plug 60. Alternatively, the ports 58 may be coupled to one or more fluid lines and the passages 46 plugged or not provided, or both the ports 58 and passages 46 coupled to fluid lines.

The female coupler 12 also includes the seal plug 70 disposed in the bore 42. As shown, the plug is disposed in a reduced diameter portion of the bore that is smaller than a diameter of the bore configured to house a collar of the male coupler. The seal plug 70 is axially movable between a closed position blocking fluid from entering or exiting the ports 48 and an open position allowing fluid to enter or exit the ports 48. The seal plug is in the closed position when the male and female couplers are uncoupled, and in the open position when the male and female couplers are coupled together.

Disposed between the seal plug 70 and an inner wall 72 of the body when the seal plug is in the closed position is at least one seal 74, and in the illustrated embodiment two seals 74 axially spaced apart on opposite sides of the ports 48. The seals 74 may be any suitable seals, such as metal seals, such as metal chevron axial seals as described in International Application No. PCT/US11/41025 which is hereby incorporated herein by reference. The seals may be held in the body in any suitable manner, for example by a retainer 79 coupled to the inner wall 72 of the body in any suitable manner, for example by threads. Disposed between the seals in an axial direction is a spacer 76. The spacer 76 includes a plurality of through-holes 78, one for each port 48, for allowing fluid to flow through the spacer to the ports 48.

The seal plug 70 additionally includes a locking mechanism 80 that engages a stab 102 of the male coupler 14 so that the plug moves axially with the stab. The metal seals 74 provide frictional resistance to movement of the seal plug 70 to enable the locking mechanism 80 to lock the stab 102 to the seal plug 70 and to allow the stab 102 to move out of the seal plug 70 once the seal plug 70 is in the closed position and the locking mechanism 80 is released. The locking mechanism 80, which may be any suitable locking mechanism such as a plurality of detents as shown, is seated in a detent groove 82 in the inner wall 72 of the body 40 when the male and female couplers are uncoupled. When the male and female couplers are coupled together (the seal plug 70 is in the open position), the detents 80 are seated in a detent groove 84 in the stab 102 to hold stab and seal plug together. To allow a portion of the respective detent 80 to be seated in the detent groove 82, the seal plug 70 includes an opening 86 through an outer wall of the seal plug for each detent to extend through.

Referring now to the male coupler 14 in detail, the male coupler includes a body 100 defining a stab 102 at the first end 18 configured to be received in the bore 42 and removably coupled to the seal plug 70. The body includes a passage 104 extending from the second end 22 of the male coupler to an inner end 106, and in the illustrated embodiment a closed inner end. The body also includes at least one port 108 extending radially outwardly from the passage 104 adjacent the inner end, and in the illustrated embodiment a plurality of ports 108. When the stab 102 is coupled to the seal plug 70, the at least one port 108 is fluidically coupled to the ports 48 in the female coupler.

The male coupler 14 also includes a collar 110 surrounding a portion of the body 100. The body 100 is axially movable relative to the collar between a closed position blocking fluid from flowing in or out of the ports 108 and an open position allowing fluid to flow through the ports 108. The collar is in the closed position when the male and female couplers are uncoupled, and in the open position when the male and female couplers are coupled together. The collar is sealed to the body by at least one seal, and in the illustrated embodiment two metal seals 114, such as metal chevron axial seals. The seals 114 are disposed between an outer wall of the body 100 and an inner wall of the collar 110, and removably coupled to the body 100 by a locking mechanism 116. The seals may be held in position by a retainer 112, which is held in position by the locking mechanism 116, and the seals may be spaced apart in an axial direction by a spacer 124. The seals may provide frictional resistance to movement of the body 100 relative to the collar.

The locking mechanism 116, which may be any suitable locking mechanism such as a plurality of detents as shown, is seated in a detent groove 118 in the outer wall of the body 100 when the male and female couplers are uncoupled. When the male and female couplers are coupled together (the seal plug 70 is in the open position), the detents 116 are seated in a detent groove 120 in the inner wall 72 of the body 40 to hold the collar 110 in position in the bore 42. To allow a port of the respective detent 116 to be seated in the detent grooves 120, the collar 110 includes an opening 122 though the outer wall of the collar for each detent to extend through.

Referring now to FIGS. 1-4, the assembly of the pressure balanced coupler 10 is discussed in detail. As shown in FIG. 2, when the female and male couplers 12 and 14 are uncoupled, the body 100 is held in the closed position by the locking mechanism 116, which is seated in the detent groove 118, and the seal plug 70 is held in the closed position by the frictional resistance from the metal seals 74 and by the locking mechanism 80, which is seated in the detent groove 82. As the stab 102 is inserted into the bore 42 of the female coupler 12, the stab 102 is received in the seal plug 70 and coupled to the seal plug by the locking mechanism 80, which is unseated from the detent groove 82 in the bore 42 and is seated in the detent groove 84 in the stab. As the stab 102 and seal plug 70 move axially towards the second end 20 of the female coupler, a front portion 130 of the collar 110 comes into contact with a shoulder 132 in the cavity, thereby preventing the collar from advancing further towards the second end 20. When the stab is advanced further, the locking mechanism 116 is unseated from the detent groove 118.

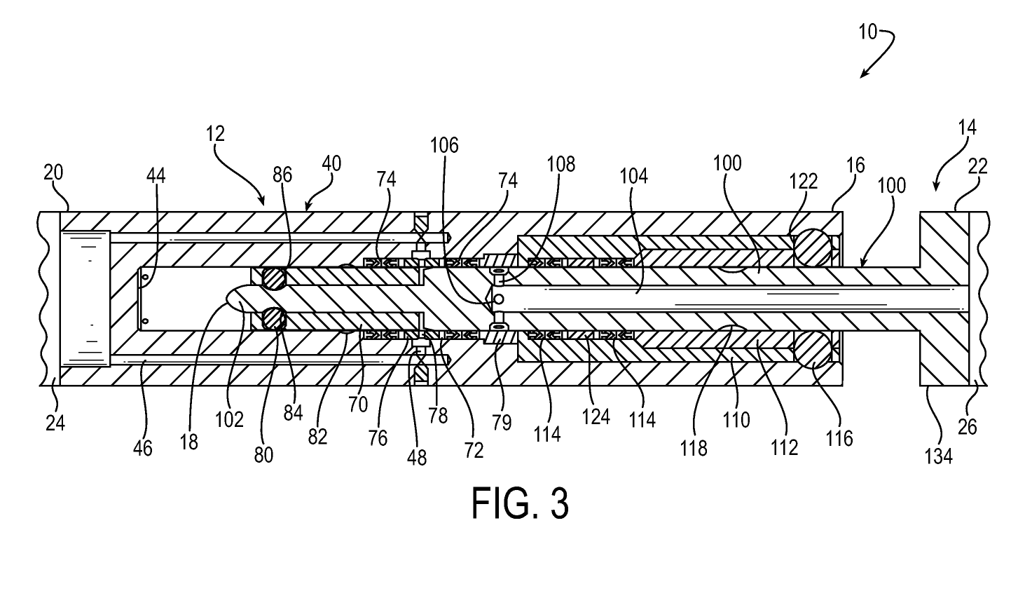

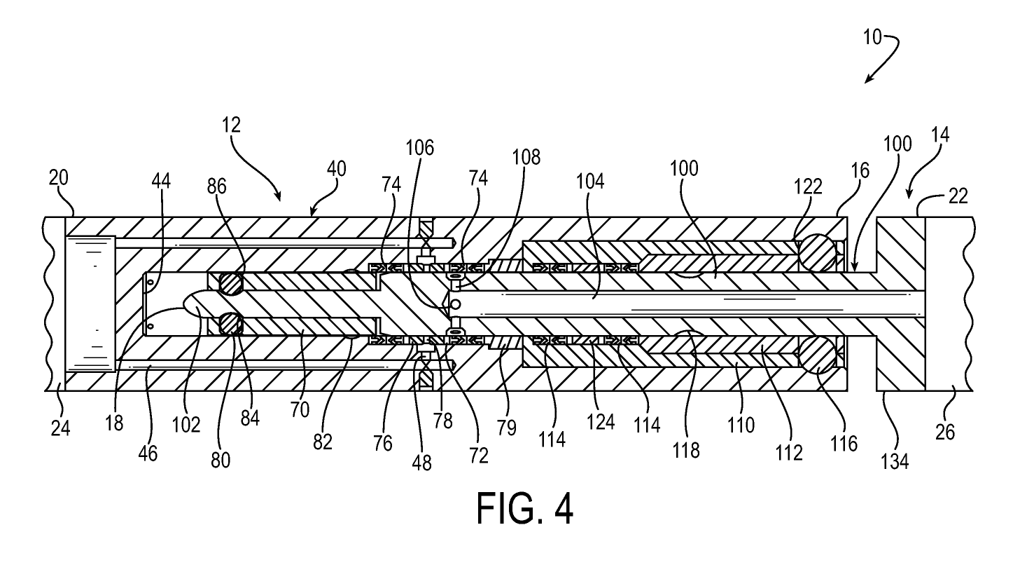

As shown in FIGS. 3 and 4, the male coupler 14 is then advanced further thereby overcoming the frictional resistance from the metal seals 74 and moving the seal plug 70 towards the open position. When the collar 110 is positioned inside the bore 42 as shown in FIG. 1, the detent 116 moves out of the detent groove 118 and into the detent groove 120, thereby allowing the male coupler 14 to fully engage in the female coupler 12. As the male coupler is advanced, fluid in the cavity 56, such as water, is forced out of the cavity through the vent holes 44. Once the locking mechanism 116 is seated in the detent groove 120, a flange portion 134 of the body 100 will abut the first end 16 of the female coupler 12 and the seal plug 70 will be in the open position.

When the seal plug 70 is in the open position, each of the ports 108 in the male coupler 14 will be aligned with one of the ports 48 in the female coupler fluidically coupling the passage 104 with the passages 46. Fluid can flow from the fluid line 26 to the passage 104, through the passage 104 to the ports 108, through the ports 108 to the ports 48, through the ports 48 to the passages 46, through the passages 46 to the cavity 50, and then from the cavity 50 to the fluid line 24. In this way, the pressure balanced coupler 10 provides a coupler for use with high pressure and/or high temperature fluids in high pressure environments that does not have a net load acting to separate the male and female couplers.

To uncouple the female and male couplers 12 and 14, the male coupler is moved axially away from the second end 20 of the female coupler. As the male coupler is being removed, the seal plug 70 moves axially with the stab 102 until the plug reaches the closed position and the locking mechanism 116 is aligned with the detent groove 118. At this point the locking mechanism 116 will be unseated form the detent groove 120 and seated in the detent groove 118, and the locking mechanism 80 will be unseated from the detent groove 84 and seated in the detent groove 82. The body 100 will then be in the closed position and stab 102 will be disconnected from the seal plug 70 to allow for further withdrawal of the stab while the seal plug is held in the closed position.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A pressure balanced coupler including:
a female coupler including:
a body having a bore and a port in a sidewall of the bore; and
a plug disposed in the bore, the plug movable between a closed position blocking fluid from entering the port and an open position allowing fluid to enter the port; and
a male coupler configured to be received in the female coupler, the male coupler including a body defining a stab configured to be received in a bore of the plug and removably coupled to the plug and a port opening to a sidewall of the stab;
wherein when the stab and plug are removably coupled the plug moves axially with the stab to the open position allowing for communication between the port in the female coupler and the port in the male coupler for enabling flow of fluid through the coupler, and upon removal of the male coupler the plug will move axially with the stab until the plug reaches the closed position after which the stab will be disconnected from the plug to allow for further withdrawal of the stab while the plug is held in the closed position.

2. The pressure balanced coupler according to claim 1, wherein the plug includes a locking mechanism that engages the stab so that the plug will move axially with the stab.

3. The pressure balanced coupler according to claim 2, wherein upon removal of the male coupler from the female coupler, the stab will be disengaged from the locking mechanism when the plug reaches the closed position.

4. The pressure balanced coupler according to claim 2, wherein the locking mechanism includes at least one detent configured to be seated in a groove on the stab when the stab and plug are coupled and in a seat in the wall of the bore when the plug is in the closed position.

5. The pressure balanced coupler according to claim 2, wherein the female coupler further includes at least one metal seal disposed between an outer wall of the female plug and a wall of the bore, the at least one metal seal providing frictional resistance to movement of the plug to enable the locking mechanism to lock the stab to the plug and to allow the stab to move out of the plug once the plug is in the closed position and the locking mechanism is released.

6. The pressure balanced coupler according to claim 1, wherein the female coupler further includes at least one passage radially offset from the bore, the passage being in fluidic communication with the bore via the port.

7. The pressure balanced coupler according to claim 1, wherein the female coupler further includes at least one vent hole extending from the inner wall of the bore to an outer wall of the body for allowing fluid in the bore to communicate with an exterior of the female coupler.

8. The pressure balanced coupler according to claim 1, wherein the bore extends from a first end of the body to a closed inner end of the body.

9. The pressure balanced coupler according to claim 8, wherein a cavity is formed in the bore between the closed inner end and the plug, and wherein the at least one vent hole is provided in the cavity.

10. The pressure balanced coupler according to claim 1, wherein the male coupler further includes a collar surrounding at least a portion of the body, the body being movable relative to the collar.

11. The pressure balanced coupler according to claim 10, wherein the male coupler includes a locking mechanism that engages a wall of the bore in the body of the female coupler to hold the collar in position in the bore.

12. The pressure balanced coupler according to claim 10, wherein the body is movable between a closed position blocking fluid from flowing through the port and an open position allowing fluid to flow through the port.

13. The pressure balanced coupler according to claim 11, wherein the locking mechanism includes at least one detent configured to be seated in a groove on the body of the male coupler when the stab and plug are uncoupled and in a seat in the wall of the bore when the plug is in the open position.

14. The pressure balanced coupler according to claim 13, wherein when the plug returns to the closed position, the detent in the male coupler will be disengaged from the seat in the wall of the bore.

15. The pressure balanced coupler according to any one of claim 10, wherein the male coupler further includes at least one metal seal disposed between an outer wall of the stab and an inner wall of the collar.

16. The pressure balanced coupler according to claim 10, wherein the body is axially movable relative to the collar between a closed position blocking fluid from flowing in or out of the port and an open position allowing fluid to flow through the port.

17. A female coupler configured to couple to a male coupler, the female coupler including:
a body having a bore and a port in a sidewall of the bore;
a plug disposed in the bore, the plug including a locking mechanism configured to engage a stab of the male coupler so that the male coupler can move the plug between a closed position blocking fluid from entering the port and an open position allowing fluid to enter the port; and
at least one metal seal disposed between an outer wall of the female plug and a wall of the bore, the at least one metal seal providing frictional resistance to movement of the plug to enable the locking mechanism to lock the stab to the plug and to allow the stab to move out of the plug once the plug is in the closed position and the locking mechanism is released.

18. The female coupler according to claim 17, wherein the locking mechanism includes at least one detent configured to be seated in the wall of the bore when the plug is in the closed position.

19. A male coupler configured to be coupled to a female coupler, the male coupler including:
a body defining a stab configured to be received in a bore of the female coupler and a port opening to a sidewall of the stab, the body being configured to be removably coupled to the female coupler;
a collar surrounding at least a portion of the body; and
a locking mechanism configured to engage a wall of the bore in the body of the female coupler to hold the collar in position in the bore when the male coupler is coupled to the female coupler;
wherein the body is movable relative to the collar.

20. The male coupler according to claim 19, wherein the locking mechanism includes at least one detent configured to be seated in a groove on the body when the male and female couplers are uncoupled.
